(19) United States
(12) Patent Application Publication
(10) Pub. No.: US 2020/0100439 A1
(43) Pub. Date: Apr. 2, 2020

(54) LEAF BLOWER

(71) Applicant: NINGBO ENERGY POWER TOOLS CO., LTD., Ningbo (CN)

(72) Inventors: Zhijun LI, Ningbo (CN); Jingkuan ZHU, Ningbo (CN); Linmiao CHEN, Ningbo (CN); Hengyu SHI, Ningbo (CN)

(73) Assignee: NINGBO ENERGY POWER TOOLS CO., LTD., Ningbo (CN)

(21) Appl. No.: 16/183,444

(22) Filed: Nov. 7, 2018

(30) Foreign Application Priority Data
Sep. 28, 2018 (CN) 201811135652.0

(51) Int. Cl. A01G 20/47; A47L 9/10

(52) U.S. Cl. CPC A01G 20/47; A47L 9/104

(57) ABSTRACT

The present invention provides a leaf blower, which includes a machine head and an air inlet channel. The machine head communicates with the air inlet channel, and the machine head is internally provided with a fan blade and a motor driving the fan blade to rotate. A lower end of the machine head is connected to a leaf collection bag. A side of the air inlet channel is provided with an opening, the opening is provided with a collecting box, and an upper end and a lower end of the opening are respectively provided with a first baffle and a second baffle. The leaf blower can effectively solve a problem that in practical application, the leaf blower may be damaged by some high-hardness small stones sucked into the leaf blower.

### CROSS-REFERENCE TO RELATED APPLICATIONS

This Non-provisional application claims priority under 35 U.S.C. § 119(a) on Chinese Patent Application No(s). 201811135652.0 filed on Sep. 28, 2018, the entire contents of which are hereby incorporated by reference.

### BACKGROUND OF THE INVENTION

### Field of the Invention

The present disclosure relates to the field of leaf suction machine technologies, and more particularly, to a leaf blower.

### Description of the Related Art

At present, with the increasing awareness of environmental protection, cleaning tools have also been greatly improved. The emergence of a leaf blower greatly facilitates the work of sanitation workers. The leaf blower has functions of cleaning, smashing and collecting fallen leaves, and enhances work efficiency of the sanitation workers. The leaf blower of the prior art includes a machine head and an air inlet channel. The machine head communicates with the air inlet channel, the machine head is internally provided with a fan blade smashing leaves and a motor driving the fan blade to rotate, and a lower end communicating with an inner cavity of the machine head is connected to a leaf collection bag. When the leaf blower works, the fan blade directly contacts and smashes collected leaves. However, the collected leaves may be mingled with some small stones. These small stones have certain hardness and may damage the fan blade and the shell of the machine head. Furthermore, some small animals hiding in the collected leaves may likely be sucked into the air inlet channel, which may injure the small animals to a certain extent. Therefore, there is provided a leaf blower which can solve the above problems.

### BRIEF SUMMARY OF THE INVENTION

For the above problems in the prior art, it is intended to provide a leaf blower which can effectively solve the problem that in practical application, the leaf blower may be damaged by some high-hardness small stones sucked into the leaf blower. Moreover, as a refuge to small animals, the collecting box may protect the small animals sucked into the leaf blower.

Specific technical solutions are described as follows.

A leaf blower includes a machine head and an air inlet channel. The machine head communicates with the air inlet channel, and the machine head is internally provided with a fan blade and a motor driving the fan blade to rotate. A lower end of the machine head is connected to a leaf collection bag. A side of the air inlet channel is provided with an opening, the opening is provided with a collecting box, and an upper end and a lower end of the opening are respectively provided with a first baffle and a second baffle.

Preferably, an edge of the first baffle is provided with a first flange perpendicular to the first baffle, and an edge of the second baffle is provided with a second flange perpendicular to the second baffle.

Preferably, a length of the first baffle is not greater than that of the second baffle.

Preferably, the second baffle is three times as long as the first baffle.

Preferably, the length of the first flange is not greater than that of the second flange.

Preferably, the second flange is twice as long as the first flange.

Preferably, the collecting box is in threaded connection with the air inlet channel.

Preferably, a mounting frame is disposed along a periphery of an edge of the opening, and an opening of the collecting box is sleeved on the mounting frame.

Preferably, the collecting box is made of a transparent material.

Beneficial effects of the above technical solutions are as below.

When the leaf blower provided by the present disclosure works, collected leaves enter an inner cavity of the machine head through the air inlet channel and is smashed by the fan blade. The collected leaves may be mingled with some small stones or small animals. Under the action of gravity, these small stones or small animals may slip along the air inlet channel and fall into the collecting box through the opening, which is provided with baffles and flanges to prevent things in the collecting box from being sucked into the air inlet channel again and from being smashed by the fan blade. In this way, the small stones or small animals may be separated, such that the fan blade and the machine shell are prevented from being damaged by the small stones, and the small animals are prevented from being injured, and thus the service life of the leaf blower is prolonged.

### BRIEF DESCRIPTION OF THE DRAWINGS

FIG. 1 is a schematic diagram of an overall structure of the present disclosure;

FIG. 2 is a schematic diagram of a partial structure of the present disclosure; and

FIG. 3 is an enlarged view of Part A in FIG. 2.

In the figures, 1—machine head; 2—air inlet channel; 3—leaf collection bag; 4—opening; 5—collecting box; 61—first baffle; 62—second baffle; 71—first flange; 72—second flange; and 8—mounting frame.

### DETAILED DESCRIPTION OF THE INVENTION

To make technical means, creative features, achieved objectives and effects of the present disclosure easy to understand, a specific elaboration of the present disclosure is made in the following embodiments with reference to the accompanying drawings.

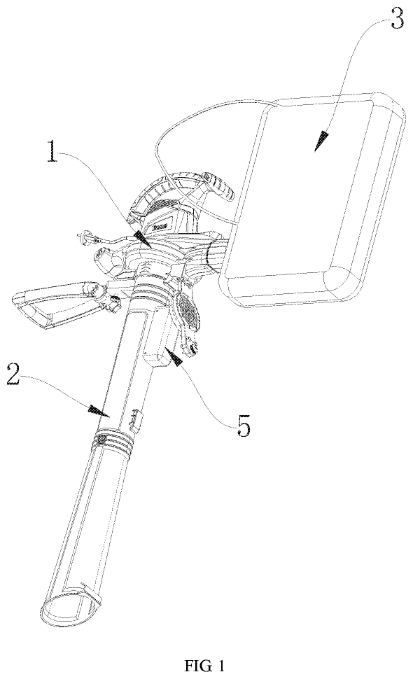

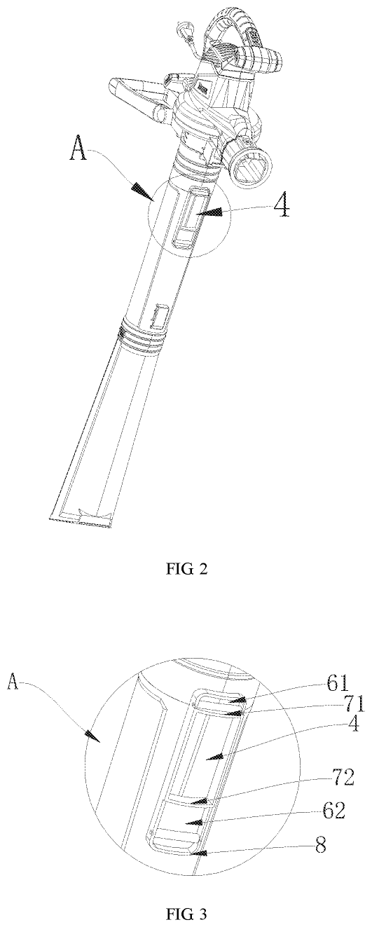

Referring to FIG. 1, FIG. 2 and FIG. 3, a leaf blower 5 is illustrated, which includes structures of a conventional leaf blower such as a machine head 1, an air inlet channel 2, and a leaf collection bag 3, etc. The machine head 1 communicates with the air inlet channel 2, and the machine head 1 is internally provided with a fan blade for smashing leaves and a motor driving the fan blade to rotate. A lower end communicating with an inner cavity of the machine head 1 is connected to the leaf collection bag 3. As an improvement of the present disclosure, a side of the air inlet channel 2 is provided with an opening 4 which is provided with a collecting box 5 used for collecting heavier small stones and small animals sucked by the leaf blower into the air inlet channel 2. Under the action of gravity, these heavier small stones and small animals may fall into the collecting box 5. Therefore, the collecting box 5 is arranged at the lower end of the air inlet channel 2 to prevent things in the collecting box 5 from being sucked into the air inlet channel 2 again. The upper end and the lower end of the opening 4 are respectively provided with a first baffle 61 and a second baffle 62, and the first baffle 61 and the second baffle 62 are integrally-molded with the air inlet channel. A specific location relation between the upper end and the lower end needs to be described here. When an operator uses the leaf blower, the air inlet channel 2 inclines to the ground. That is, by taking the ground as a flat surface, an angle is formed between the air inlet channel 2 and the ground, the upper end of the opening 4 is an end away from the ground, and the lower end of the opening 4 is an end close to the ground. In a vertical direction, the upper end of the air inlet channel 2 is an end away from the ground, and the lower end of the opening 4 is an end close to the ground.

As an improvement of the present disclosure, the length of the first baffle 61 is not greater than that of the second baffle 62. The first baffle 61 is positioned at the upper end of the opening 4, and the second baffle 62 is positioned at the lower end of the opening 4. After the small stones or small animals fall into the collecting box 5, they are at the lower end of the collecting box 5, such that the small stones or small animals may be prevented from being smashed by the fan blade. Generally, the second baffle 62 is longer than the first baffle 61, or the second baffle 62 is equal to the first baffle 61 in length. Preferably, the second baffle 62 is three times as long as the first baffle 61, which can effectively prevent things in the collecting box 5 from being sucked into the air inlet channel 2 again.

As another improvement of the present disclosure, an edge of the first baffle 61 and an edge of the second baffle 62 are respectively provided with a first flange 71 perpendicular to the first baffle 61 and a second flange 72 perpendicular to the second baffle 62. That is, the edge of the first baffle 61 is provided with the first flange 71 perpendicular to the first baffle 61, and the edge of the second baffle 62 is provided with the second flange 72 perpendicular to the second baffle 62. Both the first flange 71 and the second flange 72 are perpendicular to an axis direction of the air inlet channel 2, and both the first baffle 61 and the second baffle 62 are parallel to the axis direction of the air inlet channel 2. Presence of the flanges may further prevent things in the collecting box 5 from being sucked into the air inlet channel 2 again. Likewise, the length of the first flange 71 is not greater than that of the second flange 72. Generally, the second flange 72 is longer than the first flange 71, or the second flange 72 is equal to the first flange 71 in length. Preferably, the second flange 72 is twice as long as the first flange 71.

To clearly see the things in the collecting box 5, the collecting box 5 is made of a transparent material, such that it is convenient to observe and timely dump out the small stones or smaller animals in the collecting box 5, thereby preventing the small stones or smaller animals from being sucked into the air inlet channel 2 again.

In addition, generally the collecting box 5 is in threaded connection with the air inlet channel 2 by means of a bolt. Specifically, a mounting frame 8 is disposed along a periphery of an edge of the opening 4, and an opening of the collecting box 5 is sleeved on the mounting frame 8. A threaded hole is respectively provided on the collecting box 5 and the mounting frame 8, such that the collecting box 5 may be fixed to the mounting frame 8 by means of a bolt, and thus mounting or dismounting the collecting box 5 is convenient.

The above are merely preferred embodiments of the present disclosure, but implementations and the scope of protection of the present disclosure are not limited thereto. Those skilled in the art should appreciate that all solutions obtained based on equivalent substitutions and apparent variations by using the specification described and contents illustrated in the present disclosure shall fall within the scope of protection of the present disclosure.

What is claimed is:

1. A leaf blower, comprising a machine head (1) and an air inlet channel (2), the machine head (1) communicating with the air inlet channel (2), the machine head (1) being internally provided with a fan blade and a motor driving the fan blade to rotate, a lower end of the machine head (1) being connected to a leaf collection bag (3); wherein a side of the air inlet channel (2) is provided with an opening (4), the opening (4) is provided with a collecting box (5), and an upper end and a lower end of the opening (4) are respectively provided with a first baffle (61) and a second baffle (62).

2. The leaf blower according to claim 1, wherein an edge of the first baffle (61) is provided with a first flange (71) perpendicular to the first baffle (61), and an edge of the second baffle (62) is provided with a second flange (72) perpendicular to the second baffle (62).

3. The leaf blower according to claim 1, wherein a length of the first baffle (61) is not greater than that of the second baffle (62).

4. The leaf blower according to claim 3, wherein the second baffle (62) is three times as long as the first baffle (61).

5. The leaf blower according to claim 2, wherein a length of the first flange (71) is not greater than that of the second flange (72).

6. The leaf blower according to claim 5, wherein the second flange (72) is twice as long as the first flange (71).

7. The leaf blower according to claim 1, wherein the collecting box (5) is in threaded connection with the air inlet channel (2).

8. The leaf blower according to claim 1, wherein a mounting frame (8) is disposed along a periphery of an edge of the opening (4), and an opening of the collecting box (5) is sleeved on the mounting frame (8).

9. The leaf blower according to claim 1, wherein the collecting box (5) is made of a transparent material.
